(19) United States
(12) Patent Application Publication
(10) Pub. No.: US 2010/0176231 A1
(43) Pub. Date: Jul. 15, 2010

(54) Package-type break-preventing device for rotary shafts of a shredder

(75) Inventor: Jia-Wang Jiang, NingBo City (CN)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/318,984

(22) Filed: Jan. 14, 2009

(51) Int. Cl. B02C 23/04; B02C 15/00

(52) U.S. Cl. 241/101.2; 241/227

(57) ABSTRACT

This specification discloses a package-type break-preventing device for rotary shafts of the shredder. It consists of two bent boards, each of which has a horizontal upper board, a vertical side board, a horizontal lower board, and a vertical base. When the two boards are connected and fixed on the machine frame and tail frame, the rotary shafts and stripper are enclosed within the space formed by the two boards. The vertical side board and the horizontal lower board directly urge against the stripper, providing a supporting effect on the rotary shafts. The rotary shafts therefore do not break under an external force due to the supporting force. This achieves the goal of preventing the rotary shafts from deformation under an external force.

### BACKGROUND OF THE INVENTION

1. Field of Invention

The invention relates to a shredder and, in particular, to a package-type break-preventing device for rotary shafts of a shredder.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

A usual shredder includes a housing, a paper inlet on the front surface of the housing for inserting paper, and a shredder mechanism disposed inside the housing for shredding paper. The shredder mechanism includes cutting blades mounted on two parallel rotary shafts driven by a motor and a gearbox, thereby cutting passing paper into stripes or chips

Any given shredder has a sheet capacity according to its motor load and the strengths of the cutting blades and rotary shafts. When a lot of paper needs to be destroyed, the user has to follow the sheet capacity when inserting paper. Otherwise, inserting too much paper at a time can easily cause a paper jam. Moreover, the rotary shafts may bend when it is overloaded. If no appropriate supporting components are provided on the outer sides of the rotary shafts to balance the bending moment, the rotary shafts may even break, making the shredder out of order.

Therefore, to prevent the rotary shafts from bending under a large external force, it is necessary to provide appropriate supporting components on the outer sides of the rotary shafts.

### SUMMARY OF THE INVENTION

In view of the foregoing, an objective of the invention is to provide a package-type break-preventing device for rotary shafts of a shredder. It consists of two bent boards, each of which has a horizontal upper board, a vertical side board, a horizontal lower board, and a vertical base. When the two boards are connected and fixed on the machine frame and tail frame, the rotary shafts and stripper are enclosed within the space formed by the two boards. The vertical side board and the horizontal lower board directly urge against the stripper, providing a supporting effect on the rotary shafts. The rotary shafts therefore do not break under an external force due to the supporting force. This achieves the goal of preventing the rotary shafts from deformation under an external force.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the first embodiment of the invention;

FIG. 2 is a cross-sectional view of FIG. 1;

FIG. 3 is a three-dimensional exploded view of the second embodiment of the invention; and

FIG. 4 is a cross-sectional view of FIG. 3.

### DETAILED DESCRIPTION OF THE INVENTION

The present invention will be apparent from the following detailed description, which proceeds with reference to the accompanying drawings, wherein the same references relate to the same elements.

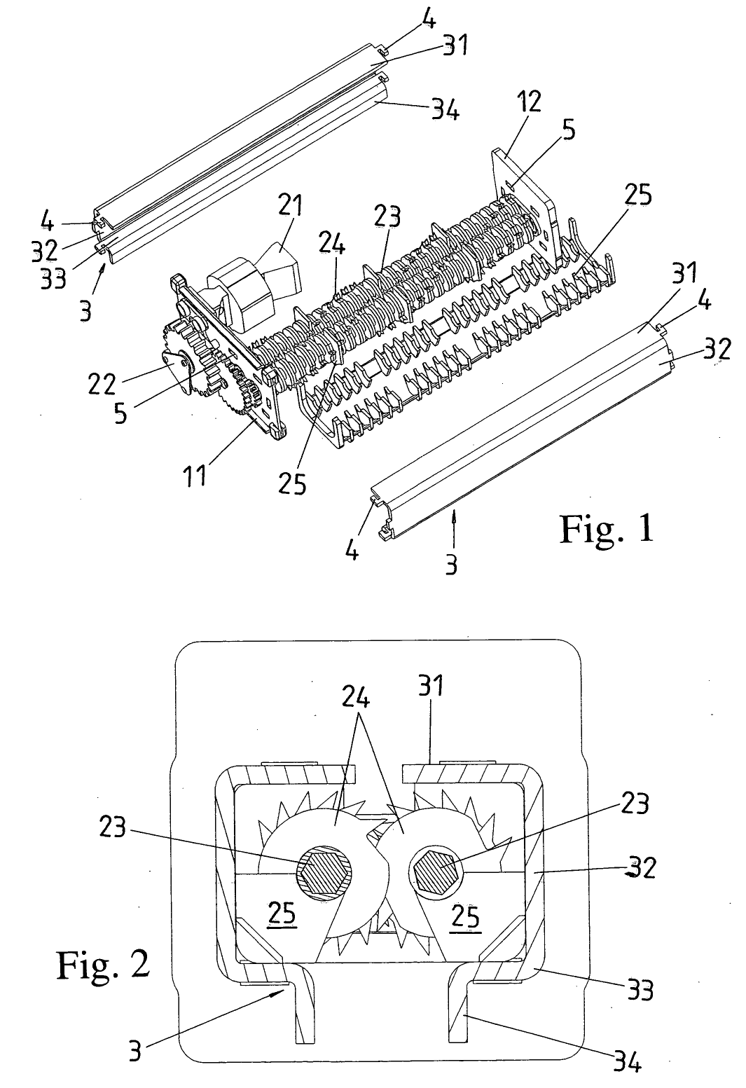

FIG. 1 is a three-dimensional exploded view of a first embodiment of the invention. FIG. 2 is its cross-sectional view. The shredder mechanism mounted on the machine frame 11 and the tail frame 12 includes a motor 21, a gearbox 22 driven by the motor 21, rotary shafts 23 driven by the gearbox 22, several blades 24 mounted on the rotary shafts 23, and a stripper 25.

When a user inserts too many sheets of paper into the rotary shafts 23 via the paper inlet of the shredder, the blades 24 are stuck to result in a paper jam. At this moment, the rotary shafts 23 may bend outward as they are overloaded. If there is no appropriate device to balance the bending moment, the rotary shafts 23 are likely to break.

The disclosed package-type break-preventing device that prevents rotary shafts from bending under an external includes two bent metal boards 3. Any of the metal boards has a horizontal upper board 31, a vertical side board 32, a horizontal lower board 33, and a vertical base 34. Both sides of the horizontal upper board 31, the vertical side board 32, and the horizontal lower board 33 have tenons for connections with the tenon holes 5 on the machine frame 11 and the tail frame 12, respectively.

As shown in FIG. 2, after the two bent metal boards 3 are positioned on the machine frame 11 and the tail frame 12 using the tenons 4 and the tenon holes 5, the rotary shafts 23 and the stripper 25 are enclosed within the space formed by the two metal boards 3. The vertical side board 32 and the horizontal lower board 33 of the metal boards directly urge against the stripper 25. The urging force produces a supporting effect on the rotary shafts 23. Therefore, the rotary shafts 23 do not break under an external force due to the supporting force.

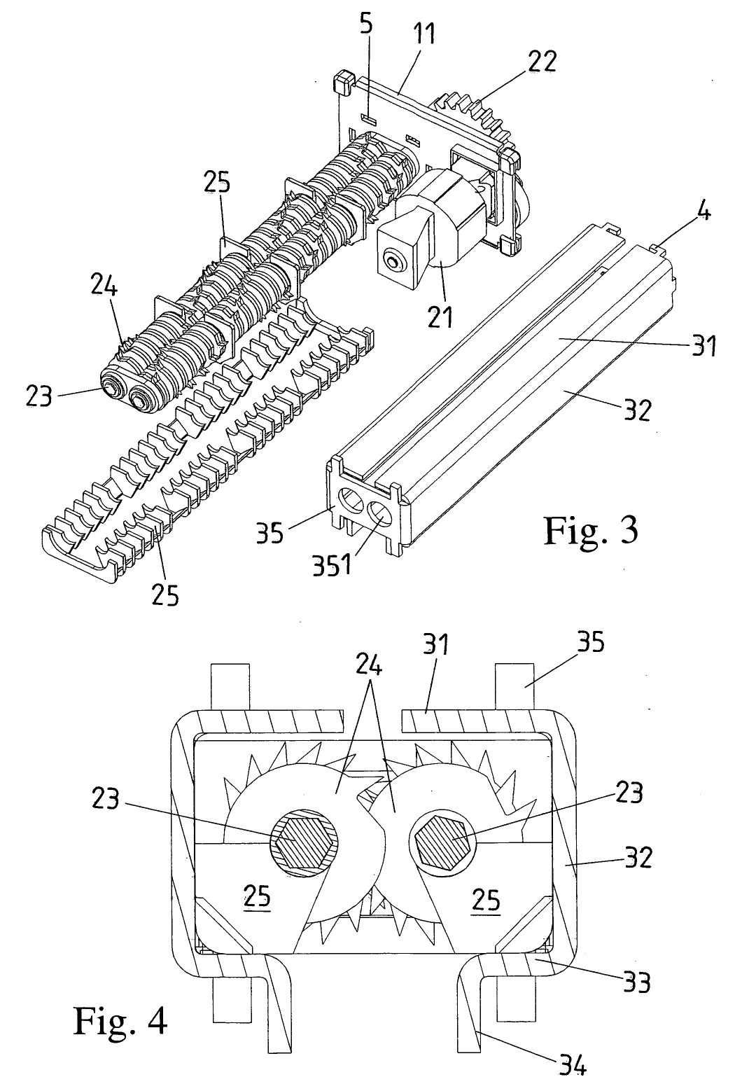

FIG. 3 is a three-dimensional exploded view of a second embodiment of the disclosed package-type break-preventing device. FIG. 4 is its cross-sectional view. This embodiment differs from the first embodiment in that one end of the two bent metal boards 3 is combined with a base board 35 to form an integral frame. The base board 35 is formed with two holes 351 for positioning the rotary shafts. As a result, the tail frame in the first embodiment is omitted and replaced by the base board 35. The horizontal upper board 31, the vertical side board 32, and the horizontal lower board 33 still have tenons 4 on their opening ends for fixing in the tenon holes 5 of the machine frame 11.

As shown in FIG. 4, after inserting the tenons 4 into the tenon holes 5 on the machine frame 11, the vertical side board 32 and the horizontal lower board 33 directly urge against the stripper 25. The urging force produces a supporting effect on the rotary shafts 23. Therefore, the rotary shafts 23 do not break under an external force due to the supporting force.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A package-type break-preventing device for rotary shafts of a shredder, comprising:
a machine frame and a tail frame;
a shredder mechanism, which is mounted on the machine frame and the tail frame and includes a motor, a gearbox driven by the motor, rotary shafts driven by the gearbox, a plurality of blades mounted on the rotary shafts and a stripper, wherein the motor and the gearbox drive the two parallel rotary shafts rotating in opposite directions to shred passing paper into chips; and
a break-preventing device, which includes two bent boards and is fixed on the machine frame and the tail frame to enclose the rotary shafts and the stripper, preventing the rotary shafts from deformation due to an external force.

2. The package-type break-preventing device for rotary shafts of a shredder as in claim 1, wherein each of the boards has a horizontal upper board, a vertical side board, a horizontal lower board, and a vertical base.

3. The package-type break-preventing device for rotary shafts of a shredder as in claim 2, wherein both sides of the horizontal upper board, the vertical side board, and the horizontal lower board have tenons, respectively, corresponding to tenon holes formed on the machine frame and the tail frame.

4. A package-type break-preventing device for rotary shafts of a shredder, comprising:
a machine frame;
a shredder mechanism, which is mounted on the machine frame and includes a motor, a gearbox driven by the motor, rotary shafts driven by the gearbox, a plurality of blades mounted on the rotary shafts and a stripper, wherein the motor and the gearbox drive the two parallel rotary shafts rotating in opposite directions to shred passing paper into chips;
a break-preventing device, which includes two bent boards and a base board that form an open frame whose opening end is fixed on the machine frame to enclose the rotary shafts and the stripper, preventing the rotary shafts from deformation due to an external force.

5. The package-type break-preventing device for rotary shafts of a shredder as in claim 4, wherein each of the boards has a horizontal upper board, a vertical side board, a horizontal lower board, and a vertical base.

6. The package-type break-preventing device for rotary shafts of a shredder as in claim 5, wherein both sides of the horizontal upper board, the vertical side board, and the horizontal lower board have tenons, respectively, corresponding to tenon holes formed on the machine frame and the tail frame.

7. The package-type break-preventing device for rotary shafts of a shredder as in claim 4, wherein the base board and the two boards are integrally fixed together and the base board is formed with two holes for positioning the rotary shafts.
